(19) United States
(12) Patent Application Publication
(10) Pub. No.: US 2009/0287739 A1
(43) Pub. Date: Nov. 19, 2009

(54) OUTAGE SCHEDULING SYSTEM

(76) Inventors: Guorui Zhang, San Jose, CA (US); Chaoyang Jing, Hamel, MN (US); Steve Lee, Palo Alto, CA (US); Peter Hirsch, Cupertino, CA (US)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/120,784

(22) Filed: May 15, 2008

(51) Int. Cl. G06F 17/00

(52) U.S. Cl. 707/104.1; 707/E17.005

(57) ABSTRACT

A system for scheduling, changing, and maintaining an outage schedule includes a data entry module adapted to allow a user to enter data pertaining to an outage, a pre-defined database containing transaction rules to define transaction flows, a processing module, and a display module. The processing module is adapted to process the data entered into the data entry module and the transaction rules provided in the pre-defined database. The display module receives processed data from the processing module, transforms the processed data into visual information representative of the processed data, and displays the visual information on a display of a computing device.

### BACKGROUND OF THE INVENTION

The present invention relates generally to a system for scheduling, changing, and maintaining an outage schedule for a power system, and more particularly to software for providing accurate information to users monitoring, planning, and working an outage.

Outages in power systems are a common occurrence that can occur for various reasons. Outages may be planned to allow maintenance to be performed on existing equipment or to implement the installation of new equipment. Outages may also be unplanned and result from equipment failure within the power system.

One of the issues that faces a power company and its' personnel is the management and scheduling of an outage. Due to the complexity of scheduling an outage, changing the schedule during the outage, and maintaining updates on the progress of the outage, it can be very difficult to audit and provide accurate information to the individuals monitoring, planning, and working the outage.

Accordingly, there is a need for scheduling systems that can be easily updated, provide an accurate account of the progress of an outage, and assist in the overall management of the outage.

### BRIEF SUMMARY OF THE INVENTION

These and other shortcomings of the prior art are addressed by the present invention, which provides a scheduling system with a workflow engine to allow auditing of an outage.

According to one aspect of the present invention, an outage scheduling system allows a user to enter, review, and update outage requests on an hourly, daily, weekly, and monthly basis.

According to another aspect of the invention, the outage scheduling system displays outaged transmission lines (tie-lines or flowgate elements) with special indications and allows users to move outages and increase or shorten outage duration.

According to another aspect of the invention, the outage scheduling system develops a pre-defined workflow process that governs the processing status of each outage, such as approval and denial.

According to another aspect of the invention, a scheduling system for coordinating an outage includes a data entry module adapted to allow a user to enter data pertaining to an outage; a pre-defined database containing transaction rules to define transaction flows; a processing module adapted to process the data entered into the data entry module and the transaction rules provided in the pre-defined database; and a display module for receiving processed data from the processing module, the display module transforming the processed data into visual information representative of the processed data and displaying the visual information on a display of a computing device.

According to another aspect of the invention, a method of coordinating an outage includes the step of providing a scheduling system having a data entry module, a processing module, and a display module. The method further including the steps of creating an outage request by entering data into the data entry module, processing the data entered into the data entry module, and displaying visual information pertaining to the outage on a display of a computing device.

According to another aspect of the invention, a method of coordinating an outage includes the step of providing a scheduling system loaded onto a computing device having a data entry module for receiving data entered by a user, a pre-defined transaction database, a processing module for processing data, and a display module for displaying visual information on a display of the computing device. The method further including the steps of creating an outage request in the scheduling system, processing the request, and displaying visual information representative of the outage request on the display.

### BRIEF DESCRIPTION OF THE DRAWINGS

The subject matter that is regarded as the invention may be best understood by reference to the following description taken in conjunction with the accompanying drawing figures in which:

FIG. 1 shows an outage scheduler viewer according to an embodiment of the invention;

FIG. 2 shows the outage scheduler viewer of FIG. 1 with an outage request detail;

FIG. 3 shows the outage scheduler viewer of FIG. 1 with an outage schedule process governed by a pre-defined workflow engine (Approve, Deny, or Review);

FIG. 4 shows the outage scheduler viewer of FIG. 1 with an outage schedule process governed by pre-defined workflow engine (Cancel or Revoke);

FIG. 5 is a workflow process state and transition table for use by a pre-defined workflow engine;

FIG. 6 shows a procedure for creating a new outage; and

FIG. 7 shows a process used by the pre-defined workflow engine.

### DETAILED DESCRIPTION OF THE INVENTION

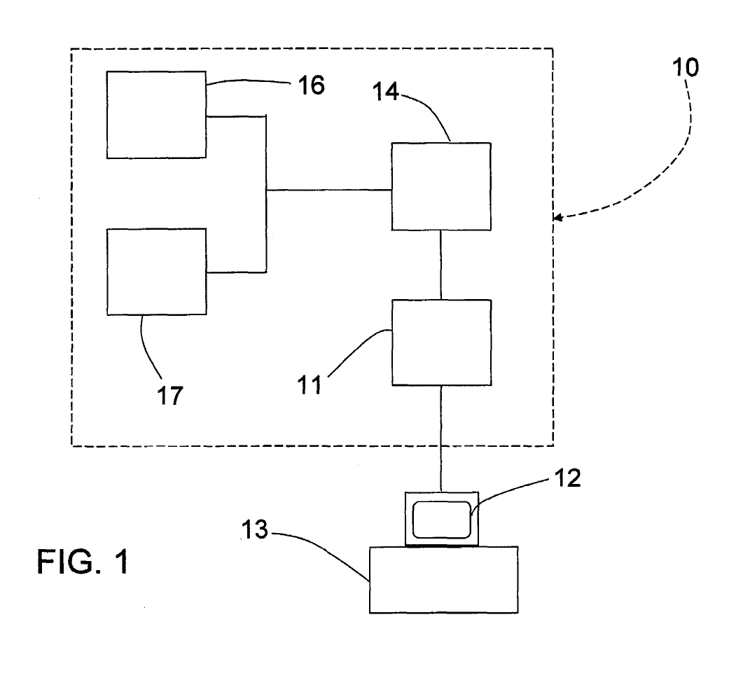

Referring to the drawings, an exemplary scheduling system according to an embodiment of the invention is illustrated in FIG. 1 and shown generally at reference numeral 10. Scheduling system 10 includes a display module 11 for displaying visual information on a display 12 of a computing device 13; a processing module 14 for processing data entered into a data entry module 16 and transaction rules contained in a pre-defined database 17.

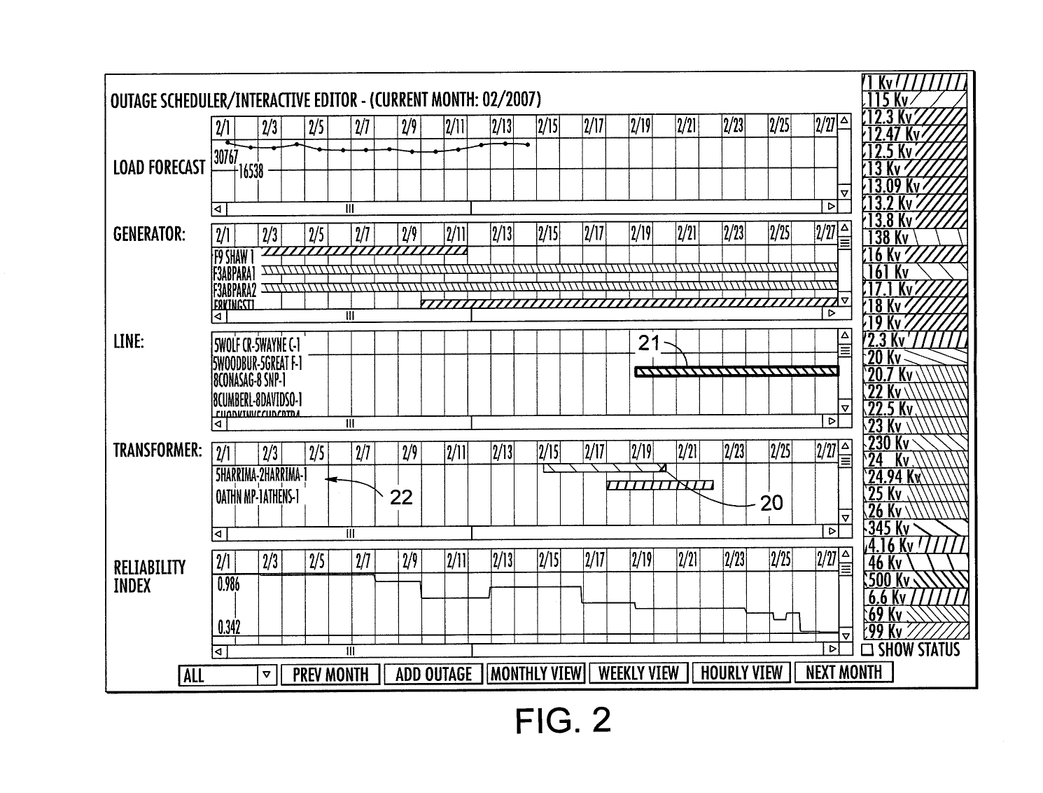

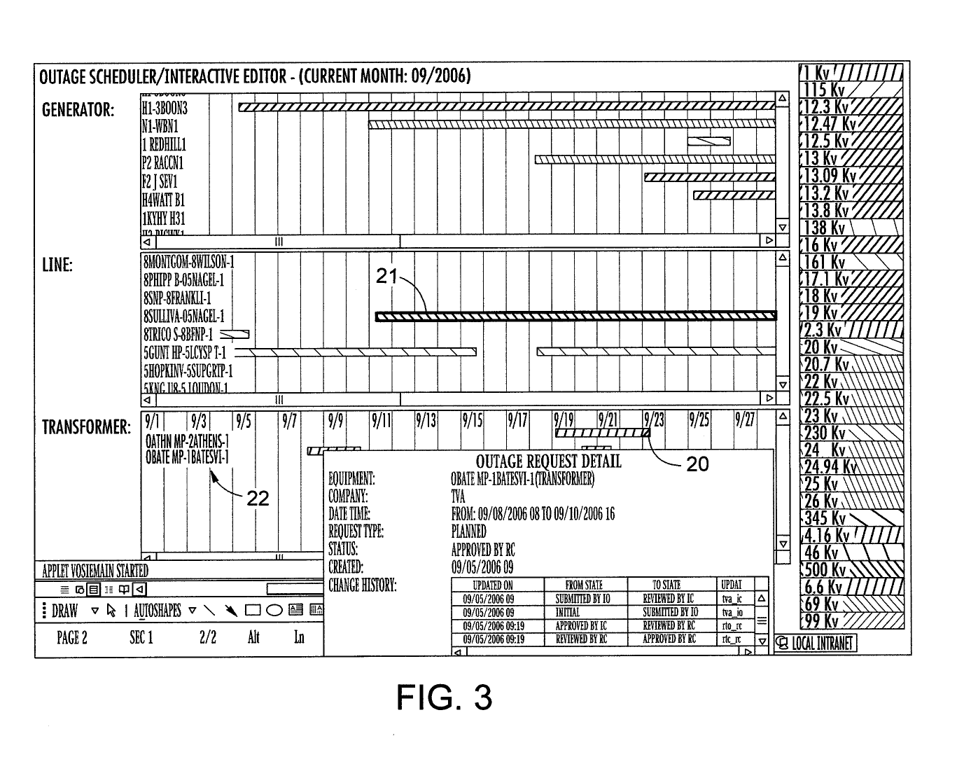

As shown in FIGS. 2 and 3, the display module 11 provides visual information in a Gantt chart type format and uses related technology for power system outage coordination. The scheduling system 10 allows a user to enter, review, and update outage requests on an hourly, daily, weekly, and monthly basis; scroll through the Gantt chart for all schedules for a specified time interval; display outage schedules on facility type (generators, lines, transformers); and display outaged transmission lines (tie-lines or flowgate/path elements) with special indicators. It should be appreciated that a transmission flowgate may be a transmission corridor, an interface, or a transmission path that consists one or more transmission lines or transformers. The user can also add new outage schedules into the chart or update the existing outage schedules, and move outages and increase or shorten outage duration.

The system 10 is further customized by defining parameters for the Gantt chart bars. For example, the width or height of the Gantt chart bars for each outage element (generator or transmission line/transformer) may be defined by the maximum capacity of each outage element or for each outage facility. The Gantt chart bars may also show outages in different colors (represented by cross-hatching) based on specifications of an electric utility and area based voltage levels. These colors may be configured in the system 10 to meet standardized colors in the industry or standardized colors for a specific facility. Other defined parameters include the length of the Gantt chart bars to show the duration of the outage, a dark triangle 20 positioned at the right lower corner of a bar to represent that there is an outage that has not been reviewed by the outage coordinator, and a black frame 21 that surrounds a bar to indicate an interface/flowgate element, a tie line, or special equipment defined by a user. Further, the system 10 allows a user to right-click on an outage bar to add textual attributes 22 to the schedule. The customization allowed by the system 10 allows an individual to perform a quick review of an outage due to the colors, symbols, text, and other visual identifications.

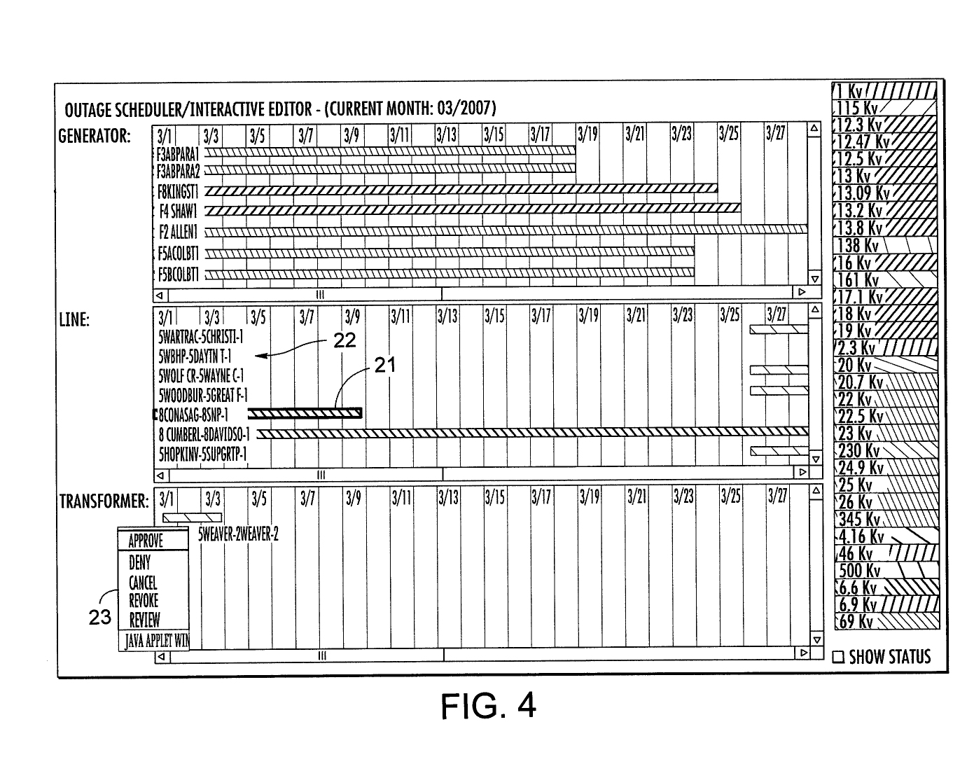

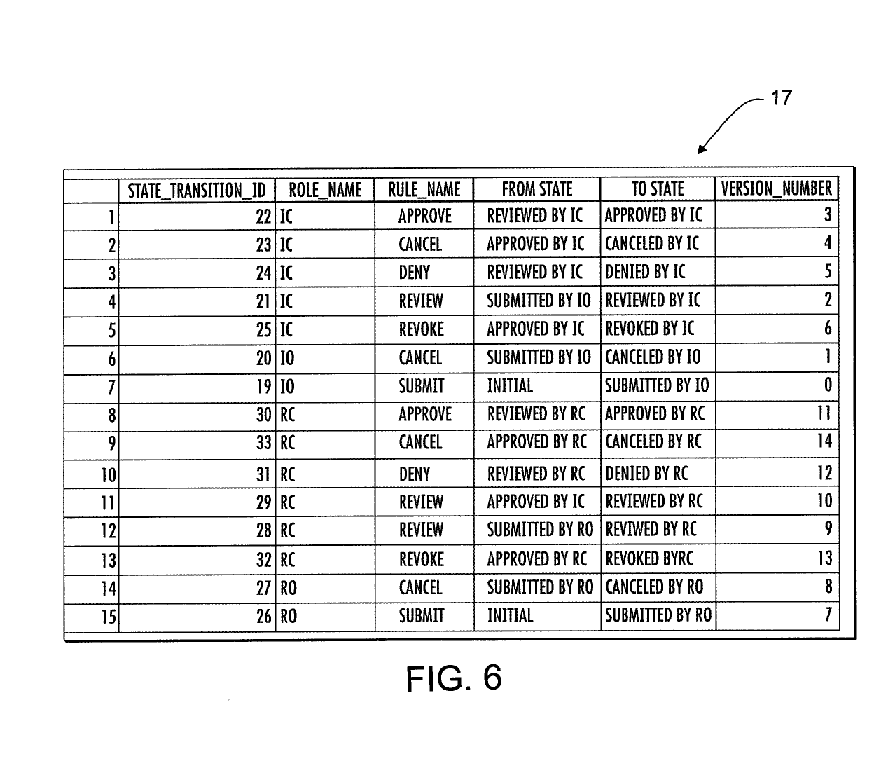

Referring to FIGS. 4-6, the processing module 14 uses a workflow engine, shown in FIG. 8, that automates and streamlines the system's 10 processes. Transaction rules for the system 10 are predefined in a database table(s) 17, shown in FIG. 6, which step through transaction flows and achieve closed loop business intelligence. The workflow driven system 10 processes make it possible to manage the process instead of the transaction, thereby eliminating the need to modify the system 10 when outage requirements change.

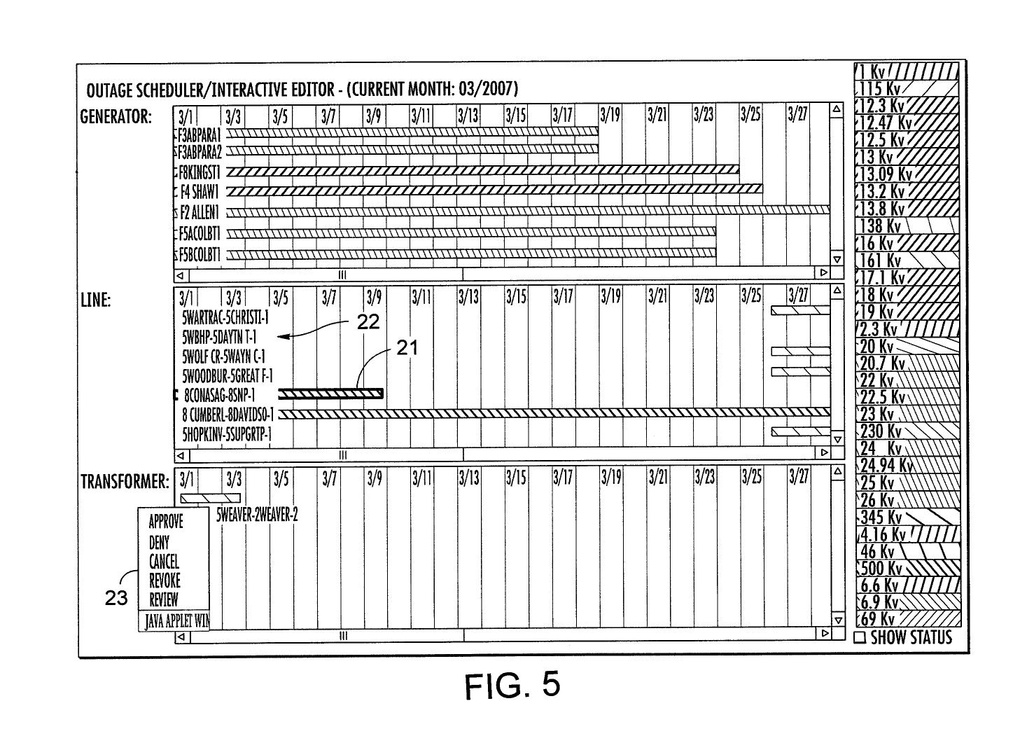

The database table(s) 17 is predefined using role, rule, and state specifications. These specifications may be modified at any time. The role specification may include “Independent Transmission Company Operator” (10), “Independent Transmission Company Coordinator” (IC), and “Regional Transmission Operator (RTO)” (RO). The RO represents operators that are responsible for transmission outage scheduling at an RTO or at an Independent System Operator (ISO). The role specification further includes a “Regional Transmission Operator (RTO) Coordinator” (RC) which includes transmission outage coordinators responsible for transmission outage coordination at an RTO or at an ISO. Other role specifications may be used. The rule specification may include Submit (an outage request), Cancel (an outage request), Review (an outage request), Deny (an outage request), Approve (an outage request), and Revoke (an outage request). In addition to being defined in the table of FIG. 5, these rule specifications as well as any other rules that may be defined are shown in FIGS. 3 and 4 at window 23 to allow the user to input a rule specification. The state specification combines the role and rule specifications and may include ApprovedByIC, ApprovedByRC, CanceledByIC, CanceledByIO, CanceledByRC, CanceledByRO, DeniedByIC, DeniedByRC, Initial, ReviewedByIC, ReviewedByRC, RevokedByIC, RevokedByRC, SubmittedByIO, and SubmittedBy RO.

With the pre-defined workflow engine, the system 10 can support audit-level detail per outage, outage request, equipment, as well as, details like created by, creation date, creation method, and version type. The benefits of this allow a user to create an audit trail describing the process in single interval experiences over time; enhance data reporting capabilities; shorten lead-times for data discrepancy analysis; automate identification & tagging of value anomalies to outage request, control areas, companies, equipments, etc; and provide dynamic looks at the data with the capability of viewing all or partial data with its corresponding detail.

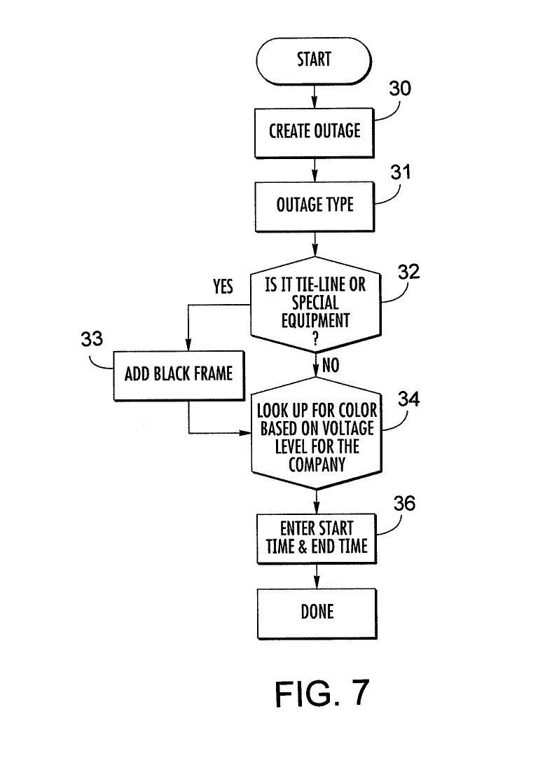

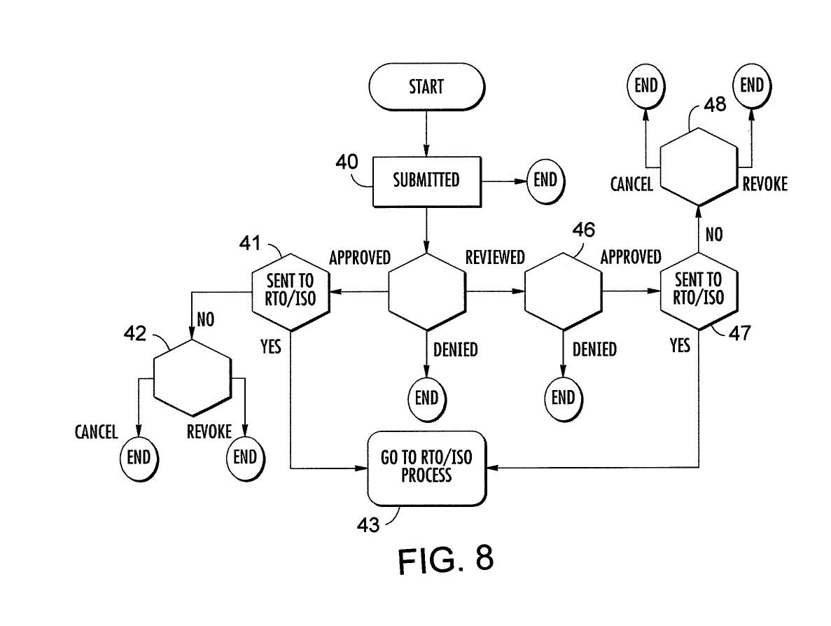

Referring to FIGS. 7 and 8, in use, a user creates an outage request, Block 30, and designates an outage type, Block 31. For example, in Block 32 when the user selects a piece of equipment to be outaged, the application will determine if the equipment is a tie-line, a special element of a transmission flowgate, a transmission path, or a transmission corridor based on predefined information. If the answer is “yes”, then a black frame 21 is added to the representative Gantt chart bar, Block 33, and the application then looks up colors based on voltage level for the facility, Block 34. The user then specifies a start time and an end time, Block 36, and ends the session.

Once the user has completed the outage request process of FIG. 7, the workflow engine processes the request as shown in FIG. 8. The submitted request, Block 40, is either Canceled, Approved, Reviewed, or Denied. If the request is canceled or denied, the workflow engine stops processing the request. If the request is approved and submitted by the transmission outage coordinator, the request is sent to RTO/ISO, Block 41, for approval. If the RTO/ISO does not approve the request, it is then either canceled or revoked, Block 42. If the request is approved by the RTO/ISO, it is sent to the RTO/ISO process, Block 43.

If the request is reviewed, the request is sent to Block 46 where it is either approved or denied. If approved, the request is sent to RTO/ISO, Block 47, for approval. If the request is not approved, it is either canceled or revoked, Block 48. If the request is approved, it is sent to RTO/ISO Process, Block 43.

The foregoing has described an outage scheduling system. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A scheduling system for coordinating an outage, comprising:
(a) a data entry module adapted to allow a user to enter data pertaining to an outage;
(b) a pre-defined database containing transaction rules to define transaction flows;
(c) a processing module adapted to process the data entered into the data entry module and the transaction rules provided in the pre-defined database; and
(d) a display module for receiving processed data from the processing module, the display module transforming the processed data into visual information representative of the processed data and displaying the visual information on a display of a computing device.

2. The scheduling system according to claim 1, wherein the transaction rules allow the system to achieve closed-loop business intelligence.

3. The scheduling system according to claim 1, wherein the data entry module is adapted to allow a user to enter outage requests on a continual basis.

4. The scheduling system according to claim 1, wherein the data entry module is adapted to allow a user to define parameters of the visual information displayed by the display module.

5. The scheduling system according to claim 4, wherein the parameters are selected from the group consisting of width of chart bars, color of chart bars, textual attributes, framing of chart bars, and chart bar symbols.

6. The scheduling system according to claim 1, wherein the predefined database includes specifications selected from the group consisting of role, rule, and state.

7. The scheduling system according to claim 6, wherein the state specification is a combination of the role and rule specifications.

8. The scheduling system according to claim 1, wherein the visual information of the display module allows a user conduct a quick review of an outage.

9. The scheduling system according to claim 1, wherein the processing module processes the data into a Gantt chart data format and the display module displays the visual information in the Gantt chart format.

10. The scheduling system according to claim 1, wherein the data entry module allows a user to update an outage request.

11. A method of coordinating an outage, comprising the steps of:
(a) providing a scheduling system, having:
(i) a data entry module;
(ii) a processing module; and
(iii) a display module;
(b) creating an outage request by entering data into the data entry module;
(c) processing the data entered into the data entry module; and
(d) displaying visual information pertaining to the outage on a display of a computing device.

12. The method according to claim 11, wherein the processing module processes the data entered into the data entry module.

13. The method according to claim 11, further including the step of updating the outage request.

14. The method according to claim 11, further including the step of adding additional outage requests.

15. The method according to claim 11, further including the step of moving outages.

16. The method according to claim 11, further including the step of increasing or decreasing time durations for specified outages.

17. The method according to claim 11, further including the step of defining parameters of a Gantt chart such that bars of the chart provide adequate visual indication to allow users to quickly review the outage.

18. The method according to claim 17, wherein the step of defining parameters of the Gantt chart includes defining a maximum capacity of an outage element or facility, defining the time duration of the outage, defining transmission lines, and defining special equipment.

19. The method according to claim 11, further including the step of defining equipment to be outaged.

20. The method according to claim 11, further including the step of defining an outage type.

21. The method according to claim 11, further including the step of defining a start time and a stop time.

22. The method according to claim 11, wherein the scheduling system further includes a pre-defined database having specifications defined to allow transaction flows and achieve closed loop business intelligence.

23. A method of coordinating an outage, comprising the steps of:
(a) providing a scheduling system loaded onto a computing device, having:
(i) a data entry module for receiving data entered by a user;
(ii) a pre-defined transaction database;
(ii) a processing module for processing data; and
(iii) a display module for displaying visual information on a display of the computing device;
(b) creating an outage request in the scheduling system;
(c) processing the request; and
(d) displaying visual information representative of the outage request on the display.

24. The method according to claim 23, wherein the step of creating an outage further includes the steps of:
(a) designating an outage type;
(b) designating a start time; and
(c) designating a stop time.

25. The method according to claim 23, wherein the step of processing the request further includes the steps of:
(a) submitting the request to a transmission outage coordinator for approval; and
(b) submitting the request to an operator for approval.

26. The method according to claim 23, further including the step of defining a tie-line.

27. The method according to claim 23, further including the step of defining piece of equipment to be outaged.
